(19) United States
(12) Patent Application Publication
(10) Pub. No.: US 2006/0247831 A1
(43) Pub. Date: Nov. 2, 2006

(54) Diagnostic information collecting device

(76) Inventor: Mitsuru Shimokoshi, Saitama (JP)

Correspondence Address: RABIN & Berdo, PC, 1101 14TH STREET, NW, SUITE 500, WASHINGTON, DC, 20005, US

(21) Appl. No.: 10/557,138

(22) PCT Filed: Jul. 29, 2004
(86) PCT No.: PCT/JP04/11189

§ 371 Date: Nov. 17, 2005

(30) Foreign Application Priority Data
Aug. 1, 2003 (JP) 2003-285170

(51) Int. Cl. G01M 17/00

(52) U.S. Cl. 701/29; 701/35

(57) ABSTRACT

A diagnostic data collection unit (10) that collects diagnostic data of a vehicle is connected to electronic control units (11) and (12) for the vehicle through a CAN, and includes a specifying device for measurement items that specifies the measurement items to the electronic control units (11) and (12), a recording device (24) for diagnostic data that records control data based on the specified measurement items and operating data of each apparatus sent from the electronic control units (11) and (12), and a storage device (25) for recorded data that stores the recorded data of the recording device for the diagnostic data of during a predetermined period before or after a trigger generating device is activated.

### FIELD OF THE INVENTION

The present invention relates to a diagnostic data collection unit used for a diagnostic system for failure and the like of a vehicle with which an electronic control unit is equipped.

### BACKGROUND INFORMATION

Recently, an electronic control unit composed of microcomputers is utilized for vehicle control and a fault-diagnostic unit for a vehicle, that collects diagnostic data from such a control unit and diagnoses faults and the like, is taken in consideration.

The fault-diagnostic unit is provided with a data memory unit. And, for instance, with respect to a defect phenomenon that occurs only while a vehicle runs, data at the time of generation of the defect phenomenon is obtained by a road test of the vehicle in a state where the vehicle is equipped with the diagnostic unit (See JP,8-166328,A, for example).

### SUMMARY OF THE INVENTION

Control of an engine and of a power train system and of the like for a vehicle, is complicated due to electronic control, so that, to understand a brief moment of phenomenon and to record data are required for diagnosis of failure and the like of the vehicle but such data is hardly obtained unless a baud rate between the fault-diagnostic unit and the electronic control unit for the vehicle is rapid, and thus, the appropriate diagnosis is not possibly made at times.

In addition, it takes time and a trouble over the diagnosis if an operability, which is of indication and setting of various measurement items to electronic control unit for the vehicle, is complicated. Moreover, for the diagnosis of the faults and the like, there is such a case that it is needed to keep a record along with the data sent from the electronic control unit.

The present invention has, in consideration of the foregoing problems, an object of providing a diagnostic data collection unit by which the diagnosis of the failure and the like is made in an accurate and easy manner.

In order to achieve the above object, the present invention includes a diagnostic data collection unit that collects diagnostic data of a vehicle. The diagnostic data collection unit includes input-output devices that communicate data with an electronic control units for a vehicle through a Control Area Network (CAN), a specifying device for measurement items that specifies the measurement items to the electronic control unit, a recording device for diagnostic data that records control data based on the specified measurement items and operating data of each apparatus, those data are sent from the electronic control unit, a trigger generating device that specifies import of the diagnostic data, and a storage device that stores the recorded data of the recording device for the diagnostic data during a predetermined period before or after at the trigger generating device is activated.

According to the present invention, since data communication with an electronic control unit for a vehicle is carried out through a CAN (Control Area Network) communication, a large amount of data can be transferred and collected speedily. Therefore, data can be recorded and stored in detail by taking a brief moment of phenomenon and a complex phenomenon with precision even if control of an engine, a power train system and the like is complicated by electronic control, and as a result, diagnosis of failure and the like can be accurately accomplished.

### BRIEF EXPLANATION OF THE DRAWINGS

FIG. 1 is an overall view of a diagnostic system.

FIG. 2 is a functional block diagram of a diagnostic data collection unit.

FIG. 3 is an explanation view of operations and processes of diagnosis.

FIG. 4 is an explanation view of operations and processes of diagnosis.

FIG. 5 is an explanation view of operations and processes of diagnosis.

### DETAILED DESCRIPTION OF THE PREFERRED EMBODIMENT

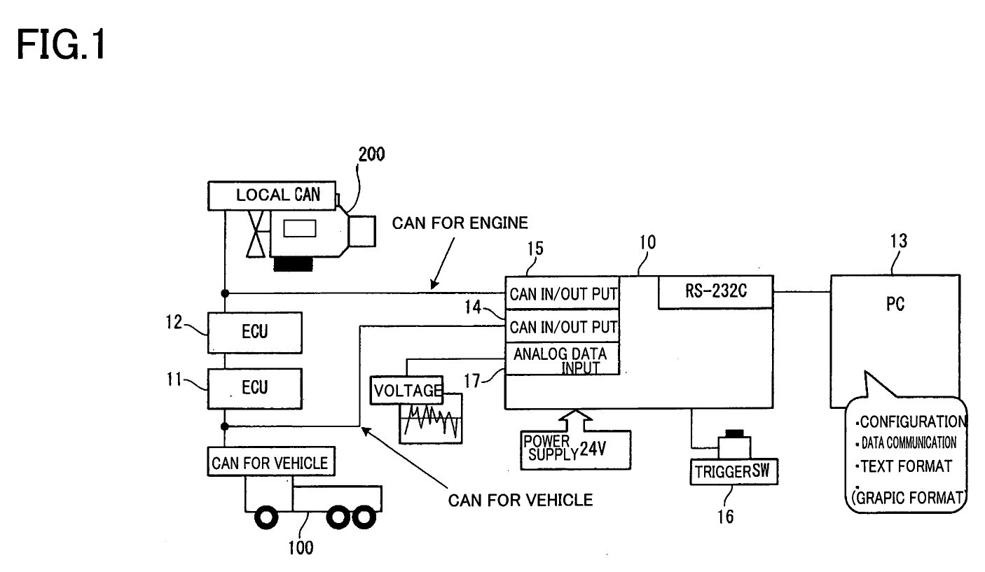

FIG. 1 is an overall view of a diagnostic system, comprising a diagnostic data collection unit 10, a control unit 11 (ECU: Electronic Control Unit) including a control system for a power train system or the like of a vehicle 100, a control unit 12 (ECU: Electronic Control Unit) for an engine 200 of the vehicle 100 and a computer 13 (PC) used for diagnostic analysis.

The vehicle control unit 11 and the engine control unit 12 are connected through a CAN (Control Area Network) in order to communicate data with each other. As for the CAN, the one, whose transmission rate is from between 256 k and 512 k bits per second to 1M bit per second, is used.

The diagnostic data collection unit 10 specifies measurement items to the vehicle control unit 11 and the engine control unit 12 and collects data for diagnostic, and the diagnostic data collection unit 10 is provided with CAN input-output terminals 14 and 15 in order to connect to the vehicle control unit 11 and the engine control unit 12 through the CAN.

Moreover the diagnostic data collection unit 10 includes a manual trigger switch 16, as one of trigger generating devices, to command to store data by an operator during a predetermined period before or after when the operator concludes that a defect phenomenon occurs, or optionally. Further, the diagnostic data collection unit 10 also includes an analog-data input terminal 17 to record a driving voltage of each sensor and a voltage state of each electronic actuator, those sensor and electronic actuator are arranged in respective apparatuses of operating systems such as an accelerator and a drive train system and an engine for a vehicle.

The computer (PC) 13 sets measurement items and the like in the diagnostic data collection unit 10 and analyzes data collected by the diagnostic data collection unit 10, as which, for instance, a personal computer is used.

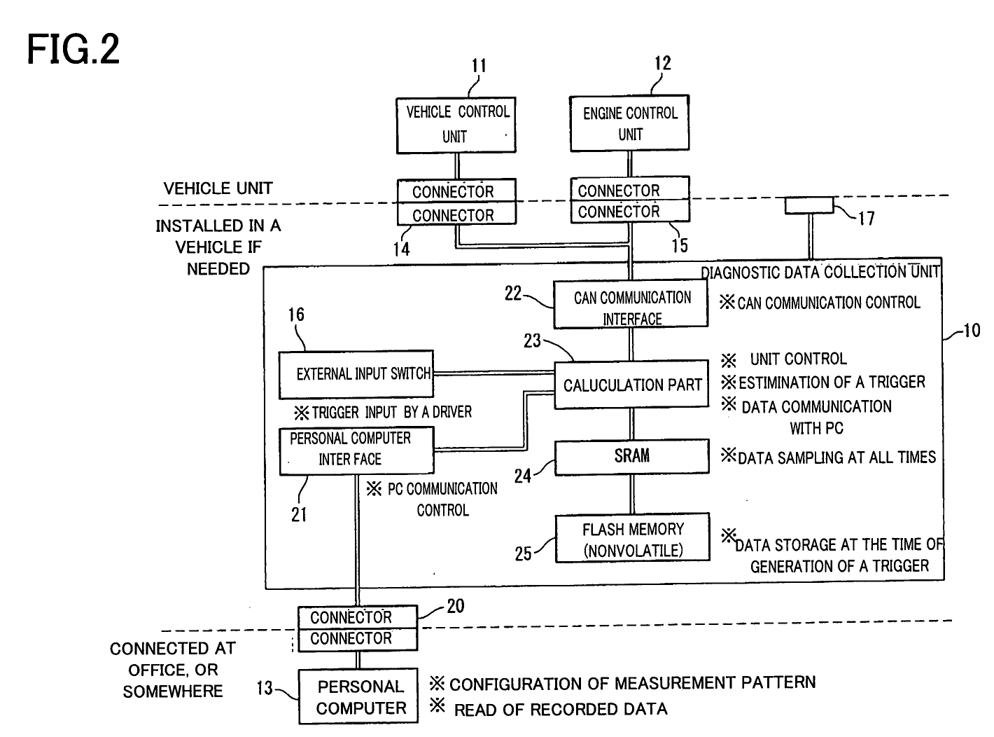

FIG. 2 is a functional block diagram of the diagnostic data collection unit 10, which comprises of, a personal computer interface 21 that communicates with the computer 13 through a connector 20, a CAN communication interface 22 that communicates with the vehicle control unit 11 and the engine control unit 12 through connectors 14 and 15 (the CAN input-output terminals), a calculation part 23 that carries out control of the diagnostic data collection unit and carries out data communication with the computer or does the like, a SRAM 24 that stores data received from the vehicle control unit 11 and the engine control unit 12, and analog-data, of such as a sensor driving voltage, inputted from the analog-data input terminal 17, a FLASH memory (nonvolatile) 25 that stores SRAM data in response to the activation of the trigger generating device (the manual trigger switch 16 and the calculation part 23).

Operations and processes of the diagnostic data collection unit 10, the computer 13, the vehicle control unit 11 and the engine control unit 12 will be now explained. First, the diagnostic data collection unit 10 is connected to the computer 13, installing a diagnostic program therein, through the connector 20 at a vehicle service station (office), or somewhere, then measurement items, measurement conditions and the like are set.

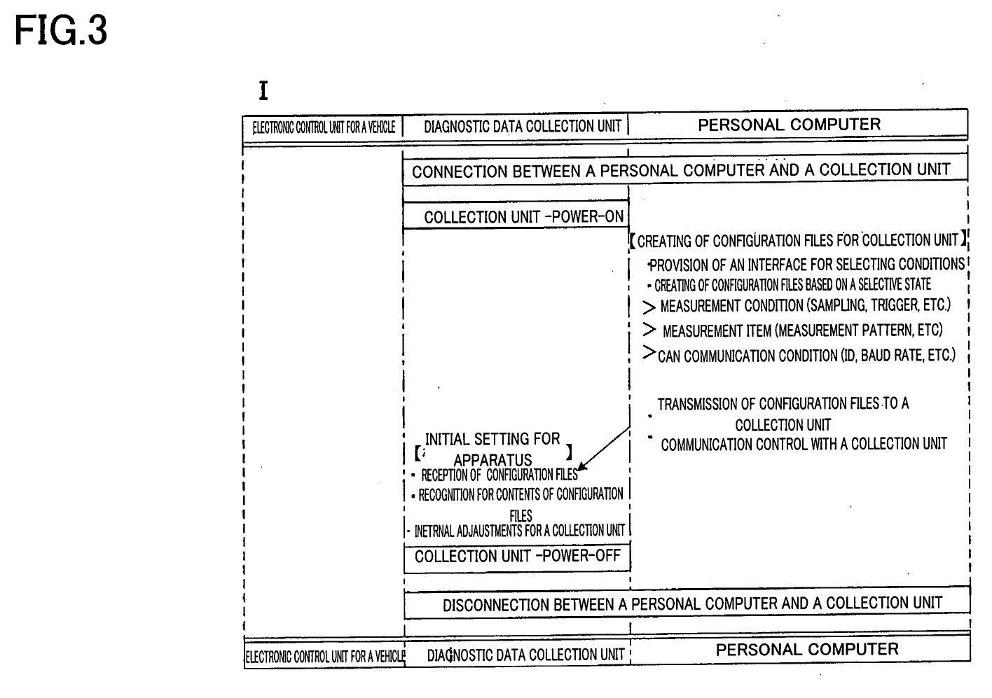

As shown in FIG. 3, a configuration file, including measurement items and measurement conditions and CAN communication conditions and the like are required for diagnosis, is created on the computer 13.

The measurement items set a pattern code number, which is patterned multi-items in accordance with contents of the diagnosis. Multi-items come from engine rotation speed, an amount of fuel injection, a fuel injection timing, an accelerator opening for a driving signal of a fuel injection valve, a clutch operation, a gear position of a transmission, a gear shift operation, an operation of each breaking system, an operation of a hydraulic system and the like.

The measurement conditions set a sampling cycle, a sampling period, a trigger condition, a measurement period for the trigger condition and the like. The trigger condition is the condition which selects of such a way as to activate a trigger by taking the calculation part 23 of the diagnostic data collection unit 10 as trigger generating devices, besides the trigger switch 16, in a case where predetermined measurement data or the analog-data to be described later enters within the range of a specific level.

The CAN communication conditions sets an ID number and the like.

In this case, the contents of the diagnosis may be selectable, and the configuration file may be created based on the selection.

In addition, a measurement of analog-data, of such as a sensor driving voltage, is selected.

The configuration file is sent from the computer 13 to the diagnostic data collection unit 10 after its file has been created.

The diagnostic data collection unit 10 recognizes the contents of the configuration file and executes internal adjustments.

After the internal adjustments are completed, the diagnostic data collection unit 10 is disconnected from the computer (PC) 13.

Next, the diagnostic data collection unit 10 is installed in a relevant vehicle, the connecters 14 and 15 are connected, and diagnostic data of when the vehicle stops and even when the vehicle runs are collected. In other words, the diagnostic data collection unit 10 is connected to the vehicle control unit 11 and the engine control unit 12 (through the CAN) and collection of data is made.

When the analog-data of, such as a sensor driving voltage, is measured, analog-data input terminal 17 is connected in order to input the analog-data through the analog-data input terminal 17.

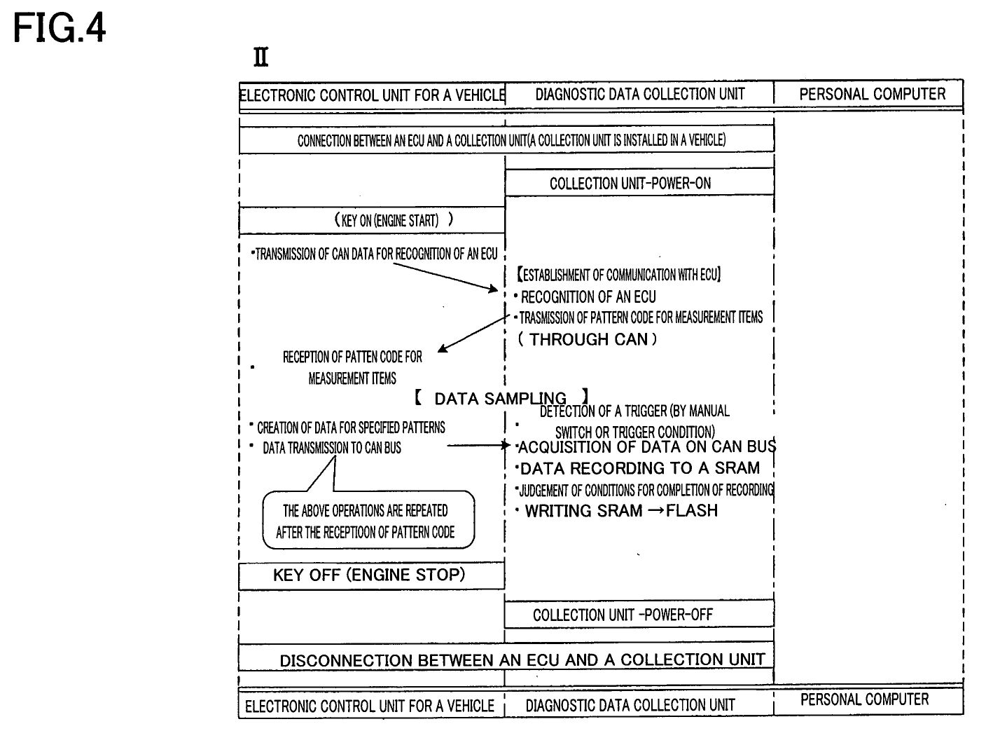

In this case, as shown in FIG. 4, when an engine key switch for the vehicle is turned on after the power of diagnostic data collection unit 10 is turned on, the vehicle control unit 11 and the engine control unit 12 send CAN data for recognition of the ECU, and thereby the diagnostic data collection unit 10 recognizes the vehicle control unit 11 and the engine control unit 12 and then sends a pattern code of measurement items, measurement conditions and the like to the relevant control unit.

After receiving the pattern code of the measurement items, the measurement conditions and the like, the vehicle control unit 11 and the engine control unit 12 start to send data and send operating data of each apparatus and relevant control data in accordance with pattern code and measurement condition and the like to the diagnostic data collection unit 10. This sending is carried out every execution cycle of control.

The diagnostic data collection unit 10 sequentially records the data sent from the vehicle control unit 11 and the engine control unit 12 in a predetermined space of the SRAM 24. In this case, after the data is sequentially recorded in from a top address to an end address, the data is again overwritten in from the top address to the end address. The record of the analog-data, of such as a sensor driving voltage, is also similarly recorded.

In addition, when the trigger switch 16 is turned on, or when a predetermined measurement data or the analog-data selected as a trigger condition enters within the range of a specific level, a trigger is considered as being activated. Then, data which is recorded in the SRAM 24 during a predetermined period before or after the trigger is activated, is written and saved to the FLASH memory (nonvolatile) 25 in accordance with the measurement conditions and the like.

This collection of data can be performed multiple times according to a capacity or the like of the FLASH memory (nonvolatile) 25.

The diagnostic data collection unit 10 is uninstalled from the vehicle after the vehicle finishes running and the data collection is completed.

Next, the data collected by the diagnostic data collection unit 10 is analyzed in the computer 13 at a service station (office), or somewhere.

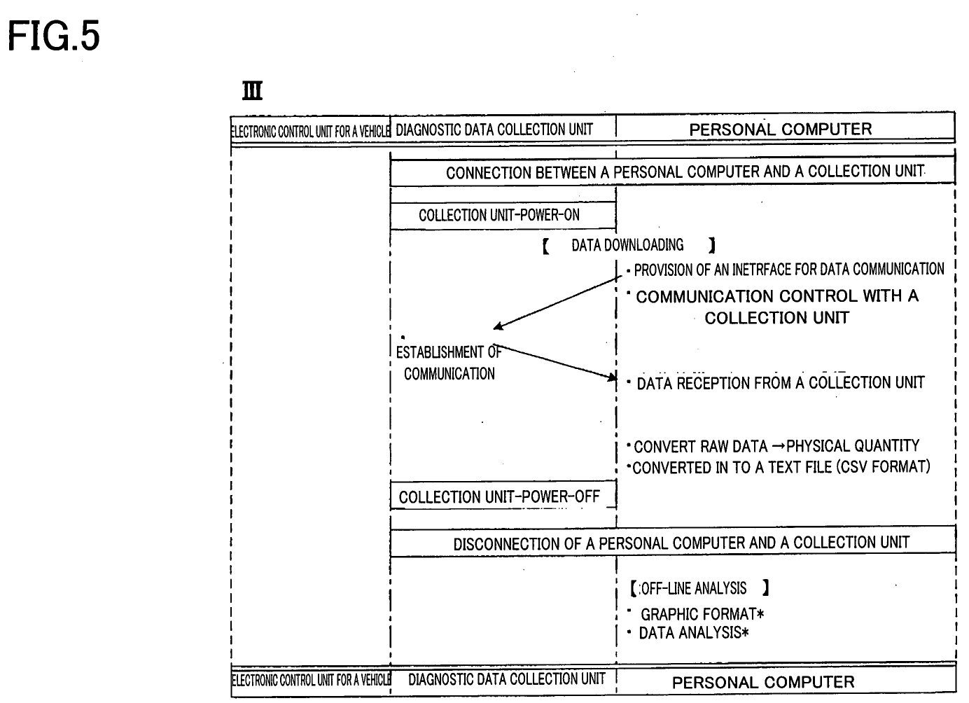

As shown in FIG. 5, the diagnostic data collection unit 10 is connected to the computer 13 and the data collected by the diagnostic data collection unit 10 is imported to the computer 13.

The computer 13 converts the collected data into physical quantity, and also converts the data into a text file of a predetermined format. After that, the data can be graphed and analyzed by analysis software, and the data is used for diagnosing.

Such arrangement can make the diagnosis of failure and the like of a vehicle be undertaken in an accurate and easy manner.

More specifically, data communication between the diagnostic data collection unit 10 and the vehicle control unit 11, the engine control unit 12 is carried out through the CAN (Control Area Network) communication whose transmission rate is rapid, in a same manner of the data communication between the vehicle control unit 11 and the engine control unit 12, so that a large amount of data can be transferred and collected speedily.

Therefore, data can be recorded and stored in detail by taking a brief moment of phenomenon and a complex phenomenon, so that diagnosis can accurately be accomplished based on the data even if control and of an engine, a power train system and the like is complicated by electronic control.

In this case, predetermined measurement data or the like is selected and when the measurement data or the like enters within the range of a specific level, the data can be collected and saved, not only when the trigger switch 16 is turned on, thus the data is easily analyzed.

Moreover, since a pattern code, which is patterned multi-items in accordance with contents of diagnosis, is used for the setting of measurement items, so that the setting is easily be done and preparation for the diagnosis is provided without a trouble. In this case, if the contents of the diagnosis are selectable, and a configuration file of the measurement items is creatable by the selection, the preparation for the diagnosis can be accurately and easily completed.

Further, since a driving voltage of each sensor and a power state of each electric actuator, besides each control data of an engine and a power train system and operating data of each apparatus, can be recorded that a defect of a drive circuit system and the like can also be analyzed, and thereby the diagnosis can be made more accurately.

### INDUSTRIAL APPLICABILITY

The present invention can be used for diagnosis of faults and the like of a vehicle with which an electronic control unit is equipped.

What is claimed is:

1. A diagnostic data collection unit that collects diagnostic data of a vehicle, comprising:
input-output devices that communicates data with an electronic control unit for a vehicle through a Control Area Network (CAN);
a specifying device for measurement items that specifies the measurement items to the electronic control unit;
a recording device for diagnostic data that records control data based on a specified measurement items and operating data of each apparatus sent from the electronic control unit;
a trigger generating device that specifies import of the diagnostic data; and
a storage device that stores the recorded data of the recording device for the diagnostic data during a predetermined period before or after the trigger generating device is activated.

2. The diagnostic data collection unit according to claim 1, wherein:
the specifying device for the measurement items specifies a pattern code installing a plurality of the measurement items to the electronic control unit.

3. The diagnostic data collection unit according to claim 2, wherein:
the pattern code is set by a computer that is externally connected and used for diagnostic analysis.

4. The diagnostic data collection unit according to claim 3, wherein:
the setting of the pattern code by the computer is provided before the vehicle runs.

5. The diagnostic data collection unit according to claim 1, wherein:
the trigger generating device is manually operated by an operator to generate a trigger.

6. The diagnostic data collection unit according to claim 1, further comprising:
a recording device for an analog voltage that records and stores a sensor driving voltage of each apparatus of the vehicle.
